(19) United States
(12) Patent Application Publication
(10) Pub. No.: US 2020/0205342 A1
(43) Pub. Date: Jul. 2, 2020

(54) COMBINE INCLUDING FEEDER HOUSE DRUM HAVING A SWEEP ASSEMBLY AND METHOD OF HARVESTING

(71) Applicant: Brian G. Robertson, Da, TX (US)

(72) Inventor: Brian G. Robertson, Da, TX (US)

(21) Appl. No.: 16/237,246

(22) Filed: Dec. 31, 2018

(51) Int. Cl. A01D 41/14; A01D 41/06

(52) U.S. Cl. CPC A01D 41/142; A01D 34/04; A01D 41/06

(57) ABSTRACT

A harvesting combine having a feeder house drum assembly is provided herein, wherein the feeder house drum may include a sweep assembly that provides sufficient grasp upon the crops without having a damaging effect, wherein the crop throughput is improved while reducing damage to the crop. Coupling to receive the crop bearing grain from a conveyor, the sweep assembly may comprise either a panel or brush assembly coupled to a respective one of a plurality of paddle anchors that couple to the feeder house drum. In particular, each brush assembly may include at least one row of finger members coupled to a brush base, wherein the finger members may be arranged in tufts and received in stepped openings through the brush base. The finger members may include at least one row of straight or curved brush bristles; or at least one row of curved elongated fingers.

### BACKGROUND

In the agricultural industry, combine harvesters are used for reaping, threshing and winnowing a variety of grain crops from a field. These machines typically include a header assembly, which severs crop materials close to the ground as the combine is driven across a field. A feeder assembly moves the severed crop materials from the header assembly through a feeder house drum to a threshing area of the combine. In operation, the combine cuts and gathers the crop standing within a field, and feeds the cut crop to a separator by means of a conveyor mechanism and a second conveyor assembly. This conveyor mechanism moves the severed crop materials from the header assembly towards a threshing assembly, where the rotor in combination with threshing concaves, thresh the grain. In particular, when the grain is threshed, the crop material is shaken or beaten to loose the grain from the husk, stems, pods, or cobs, such that the threshed grain is separated from crop Material Other than Grain (MOG). A separator assembly separates the threshed grain from the MOG. This grain is moved to a grain tank. The crop MOG, such as chaff, straw, vines, stems, and leaves, are then chopped and spread upon the field.

In operation, the conveyor mechanism retrieves crop material from the header where it is cut from the field, and moves it upwardly along an interior portion of the housing for the feeder assembly to the second conveyor assembly, for distribution to the separator mechanism. In particular, the conveyor mechanism can include a plurality of continuous chains arranged in parallel that revolve around a transverse drum at the front of the feeder assembly and transverse sprocket means at the rear of the feeder assembly. Rotating generally in the direction of the length of the combine, the chains include a plurality of transverse slats connected to the chains at each end of the slat, which engage the crop, moving the crop in a rearward motion along the interior portion of the housing of the feeder assembly. The crop is feed into the second conveyor mechanism having paddles that push the crop upwards to the separator mechanism. Typically, the paddles are metal, having blunt edges, which perform the function of taking the crop material from the feeder assembly and ultimately, transporting the same to the threshing assembly.

However, due to the abrasive serrated-like edges of the paddles, as well as the hard and non-forgiving paddle composition, the crop is most often damaged by the paddles during its transportation to the threshing assembly. In particular, given the following: (1) the speed at which the paddles grab the crop material, (2) the abrasive manner in which the paddles grab the material, and (3) the blunt hard edges of the paddles (which are often made of steel), frequent damage to the crops occur. This damaged crop translates into damaged grain, which brings a yield and financial loss to the farmer. Particularly, there are several ways in which the conventional metal paddle causes loss. First, the cracked and damaged grains fall out of the feeder house drum portion of the feeder house assembly and are lost in the field, before the grains enter the threshing assembly. Second, most cracked and damaged grains are not captured by the combine during the threshing step and are passed out the back with MOG (such as chaff, straw, vines, and the like). In particular, the separator may include separation concave grates that are used to separate the grain from the MOG at the rear end of the combine. The separation concave grates have openings allowing the separated grain to fall through and be captured by the combine, while the MOG is dispersed out the back of the combine. However, due to the damage, some of the grain is mistaken for MOG and dispersed out the back of the combine with the MOG. Another reason the conventional metal paddle causes loss is that the combine may capture the cracked and damaged grain, but when this damaged grain is stored in the grain bin, these damaged grains further crumble into dust, which yields more loss. All farmers experience this type of loss. It is one of the most impactful reasons for loss suffered by the farming industry. To make matters worse, the cracked/damaged grain is typically “docked” by an inspector (or grain elevator), who receives the purchased grain and reviews it for inspection. Upon finding the cracked/damaged grain, the grain elevator docks the farmer, requiring him to sell the grain at a discounted price because of the damage. This is yet another reason for the loss experienced within the agriculture industry.

It is within this context that the embodiments arise.

### SUMMARY

Embodiments of a harvesting combine having a feeder house drum including a sweep assembly with a brush or panel assembly is provided. It should be appreciated that the present embodiment can be implemented in numerous ways, such as a process, an apparatus, a system, a device, or a method. Several inventive embodiments are described below.

In some embodiments, a harvesting combine having a feeder house drum assembly with a brush assembly that provides sufficient grasp upon the crops without having a damaging effect is provided. In a combine for harvesting a crop bearing grain, a feeder house mechanism may include a conveyor for conveying grain from a harvesting platform to a feeder house drum. In particular the feeder house mechanism may coupled to the harvesting platform at a forward crop inlet and deliver the same to a rear opening. The feeder house drum may include one or more paddles each having a respective sweep assembly, wherein the feeder house drum couples to receive the crop from the rear opening without damaging the crop. Each sweep assembly may include a brush assembly that comprises at least one row of finger members coupled to a brush base, wherein the material of each member is rigid, semi-rigid, and/or flexible, such that each member is notably less abrasive and damaging to the crop than the traditional use of metal. The finger members may be arranged in tufts and received in stepped openings through the brush base. The finger members may also include at least one row of straight or curved brush bristles; or at least one row of curved elongated fingers. In some embodiments, the sweep assembly may include one or more panels, wherein the material of each panel is rigid, semi-rigid, and/or flexible, such that each panel is notably less abrasive and damaging to the crop than the traditional use of metal.

In some embodiments, a feeder house drum for a harvesting machine such as a combine is provided. The feeder house drum may include a cylinder having a plurality of paddle anchors coupled thereto, wherein one or more paddles couple to the plurality of paddle anchors for the grasping of the crop in an effort to mitigate damage thereto. The paddle may include a brush assembly coupled to a paddle base to retrieve the crop from the harvesting platform without damaging the crop. The paddle base may include a forward end and a rearward end, wherein the brush assembly may be coupled to either end. The paddle base may also include one or more through-material recesses for fastening the paddles to a respective one of the paddle anchors using a fastening means. The brush assembly may include at least one row of finger members coupled to a brush base, wherein the material of each member is rigid, semi-rigid, and/or flexible, such that each member is notably less abrasive and damaging to the crop than the traditional use of metal. The finger members may comprise a plurality of brush bristles arranged in tufts and received in stepped openings through the brush base. Alternatively, the finger members may include at least one row of curved elongated fingers or flat rectangular fingers. The finger members may be made of a variety of materials including rubber, composite rubber, plastic, composite plastic, and the like.

In some embodiments, a method of processing of crop material through a harvesting combine feeder house is provided; wherein, the harvesting combine having a feeder house drum mounted to capture retrieved crop from a feeder house. In one embodiment, the method may include providing crop material at an inlet of the feeder house using a harvesting platform. The method may also include gripping the crop material using a conveyor within the feeder house and moving the crop from one end of the feeder house to the other. For example, gripping the material may include gripping the crop material using a plurality of slats secured to at least at least two continuous conveyor chains being entrained around a sprocket drive means and a transverse drum so as to move laterally in the feeder house, around the transverse drum and the sprocket-driven means. The method may further include pulling the gripped crop material from the conveyor by a feeder house drum having one or more paddle anchors, wherein a sweep assembly coupled to the one or more paddle anchors pulls the crop. For example, the sweep assembly may include a brush assembly, having at least one row of finger members, that couple to a paddle base for pulling and sweeping the crop material from the conveyor in a way that mitigates damage to the crop. Additionally, the method may include providing the crop material to a threshing mechanism for separating the grain form the crop material other than grain using the brush mechanism. Further, the method may comprise separating the grain from the crop material other than grain, using the separator.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one so skilled in the art without departing from the spirit and scope of the described embodiments.

FIG. 1 is a side view of a combine having feeder house drum with a plurality of paddles each having a sweep assembly, in accordance with some embodiments.

FIG. 2 is a perspective view of a feeder assembly of a combine incorporating chain slats and a feeder house drum having the sweep assembly including brush bristles, in accordance with some embodiments.

FIG. 3A is a perspective view of one embodiment of a feeder house drum with a plurality of paddles having a full head brush assembly in accordance with some embodiments.

FIG. 3B is a perspective view of one embodiment of a feeder house drum with a plurality of paddles having a full panel assembly in accordance with some embodiments.

FIG. 4A is a perspective view of one embodiment of a paddle having a brush assembly covering a portion of the paddle base in accordance with some embodiments.

FIG. 4B is a perspective view of one embodiment of a paddle having a brush assembly covering a portion of the paddle base including curved elongated fingers in accordance with some embodiments.

FIG. 4C is a perspective view of one embodiment of a paddle having a panel assembly covering a portion of the paddle base including a panel having notches in accordance with some embodiments.

FIG. 4D is a perspective view of one embodiment of a paddle having a brush assembly covering a portion of the paddle base including elongated cylindrical fingers in accordance with some embodiments.

FIG. 5 is an exemplary flow diagram of a method for harvesting grain using the harvesting combine including a feeder house drum having a brush assembly, in accordance with some embodiments.

### DETAILED DESCRIPTION

The following embodiments describe harvesting combine having a feeder house drum including a sweep assembly. It can be appreciated by one skilled in the art, that the embodiments may be practiced without some or all of these specific details. In other instances, well known process operations have not been described in detail in order not to unnecessarily obscure the embodiments.

A harvesting combine having a feeder house drum assembly with a brush assembly that provides sufficient grasp upon the crops without having a damaging effect is provided. In a combine for harvesting a crop bearing grain, a feeder house mechanism may include a conveyor for conveying grain from a harvesting platform to a feeder house drum. In particular the feeder house mechanism may coupled to the harvesting platform at a forward crop inlet and deliver the same to a rear opening. The feeder house drum may include one or more paddles each having a respective sweep assembly comprising either a brush or panel assembly, wherein the feeder house drum couples to receive the crop from the rear opening without damaging the crop. Each brush assembly may include at least one row of finger members coupled to a brush base. The finger members may be arranged in tufts and received in stepped openings through the brush base. The finger members may also include at least one row of straight or curved brush bristles; or at least one row of curved elongated fingers. In the alternative, each sweep assembly may include a panel coupled to the brush base. The finger members may also include at least one row of elongated cylindrical fingers.

In some embodiments, the plurality of paddles of the feeder house drum for a harvesting combine may comprise a full brush assembly coupled to a paddle base to retrieve the crop from the harvesting platform without damaging the crop. In the alternative, the feeder house drum may comprise a plurality of paddles having a full panel assembly coupled to the paddle base. Moreover, the plurality of paddles may comprise a partial brush assembly coupled to either a forward end or a rearward end of the paddle base. The paddle base may also include a plurality of through-material recesses at the outer ends of the base for fastening the paddles to the cylinder using a fastening means. The brush assembly may include at least one row of finger members coupled to a brush base. The finger members may comprise a plurality of brush bristles arranged in tufts and received in stepped openings through the brush base. A bristle may include narrow finger members comprising, composite plastic, composite rubber, composed of rubber, composite rubber, plastic, composite plastic, synthetic material, and the like. A bristle is a stiff, firm strand of material. Alternatively, the finger members may include at least one row of curved elongated fingers or flat rectangular fingers. The finger members may be made of a variety of materials including rubber, composite rubber, plastic, composite plastic, and the like.

In operation, a method of processing of crop material through a harvesting combine feeder house is provided; wherein, the harvesting combine having a feeder house drum mounted to capture retrieved crop from a feeder house without damaging the crop. In particular, the method may include providing crop material at an inlet of the feeder house using a harvesting platform. The method may further include gripping the crop material using a conveyor within the feeder house and moving the crop along the interior of the feeder house assembly. For example, gripping the material may include gripping the crop material using a plurality of slats secured to at least at least two continuous conveyor chains being entrained around a sprocket drive means and a transverse drum so as to move laterally in the feeder house, around the transverse drum and the sprocket-driven means. Additionally, the method may further include pulling the gripped crop material from the conveyor by a feeder house drum, wherein a panel or brush assembly coupled to the feeder house drum sweeps the crop. For example, the brush assembly, having at least one row of finger members, may couple to the base of the paddle for pulling and sweeping the crop material from the conveyor. Moreover, the method may include providing the crop material to a threshing mechanism for separating the grain form the crop material other than grain using the brush mechanism. Further, the method may comprise separating the grain from the crop material other than grain, using the separator.

Advantageously, the feeder house drum with a plurality of paddles in accordance with some embodiments incorporates a stiff brush to pull the crop into the separator mechanism for separating the grain from the crop. The feeder house drum with a plurality of paddles having a sweep assembly, in accordance with embodiments disclosed herein, is much more forgiving to the crop than current feeder house drums existing on the market. In particular, the sweep assembly does not contain a sharp, hard edge that damages the crop as the current feeder house drums possess; yet, the sweep assembly is still stiff enough to effectively move the crop along the feeder house path to the separator mechanism. The feeder house drum in accordance with some embodiments includes a more effective paddle design to harvest the crop over existing technologies. The feeder house drum with a plurality of paddles in accordance with some embodiments effectively eliminates damage to the crop. That is, no grain or yield loss exists in the feeder house drum portion of the harvesting combine, when the feeder house drum having the sweep assembly disclosed herein is implemented with a combine design, as opposed to the damaged grain that typically occurs with existing technologies.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

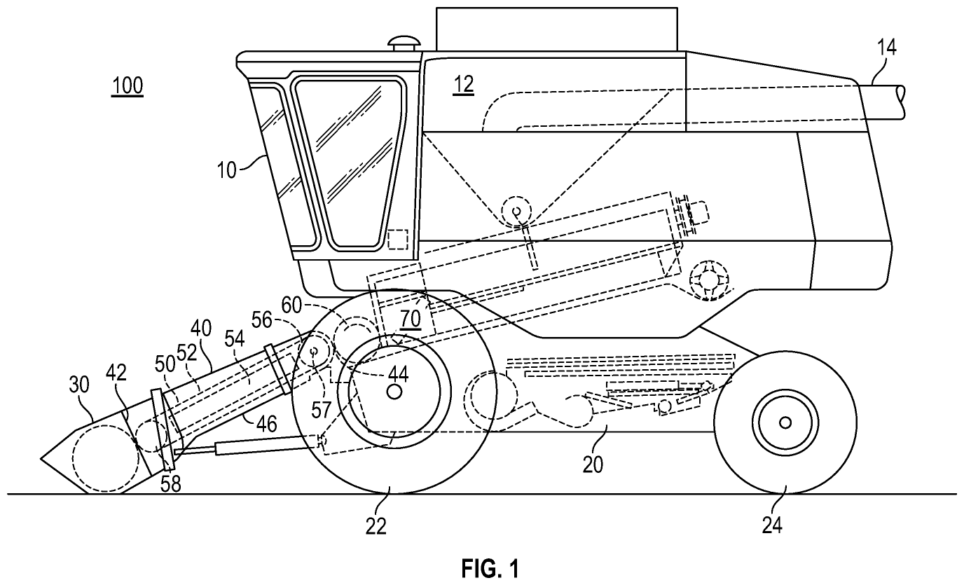

Referring to FIG. 1, a side view of a combine having feeder house drum with a plurality of paddles each having a sweep assembly is illustrated. In particular, a side view of a combine 100 having a feeder house drum 60 with a plurality of paddles each having sweep assembly, in accordance with some embodiments is shown. The combine 100 for harvesting agricultural crops may include a supporting structure 20 having ground-engaging wheels 22, 24 extending from the supporting structure 20. The operation of the combine 100 may be controlled from the operator's cab 10. In the alternative, the combine may be remotely controlled by a controlling mechanism (not shown). The combine 100 may also include a harvesting platform 30 used for harvesting a crop bearing grain. In particular, when the crop is cut by the harvesting platform 30, it is directed to a crop inlet 42 at the front of a feeder house 40. The feeder house 40 may comprise a conveyor mechanism 50 that directs the crop upwardly and rearwardly through the feeder house 40. The crop may then be directed out of the feeder house 40 through a rear opening 44 to a feeder house drum 60 to a separator mechanism 70, which threshes the grain from the crop material. In particular, the feeder house 40 has an internal frame 54, which is used to provide support and structure to the feeder house mechanism 40. The feeder house 40 also has an upwardly and rearwardly inclined housing 46. Once the grain has been separated from the crop material, it is fed into a grain tank 12, and is ultimately dispersed from the combine 100 by means of the unloading auger 14 into other transport or storage mechanisms.

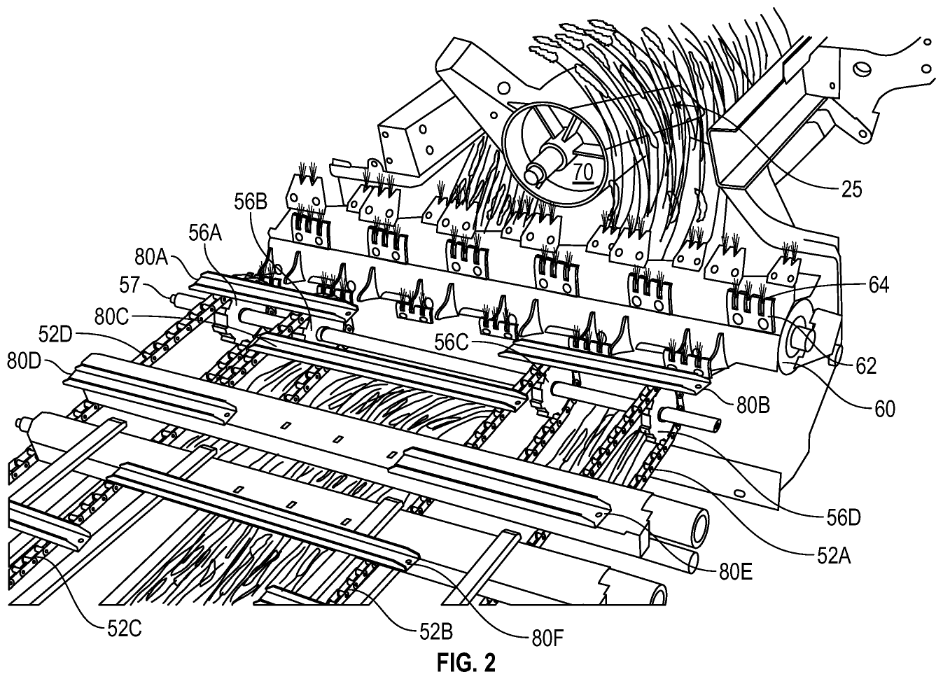

As shown in FIG. 1, the chain-and-slat crop feeding conveyor 50 may include rear drive sprocket means 56 adjacent to the rear portion of the feeder house 40, near the feeder house drum mechanism 60, and a transverse drum 58 mounted on a shaft adjacent to the forward end of the feeder house 40. The rear drive sprockets 56 can be mounted on a shaft 57, which is driven from a power source (not shown) within the combine 100. More particularly as shown in FIG. 2, a perspective view of a feeder assembly of a combine 100 incorporating chain slats and a feeder house drum having the sweep assembly including brush bristles in some embodiments is provided. The feeding conveyor 50 may include conveyor chains 52, which run parallel to each other and are spaced equidistant from each other are entrained around the rear drive sprockets (56a, 56b, 56c) and the front transverse drum (FIG. 1: 58). The chains 52a, 52b, 52c and 52d are continuous chains that move laterally within the feeder house 40, around the transverse drum (FIG. 1: 58) and the sprockets (56a, 56b, 56c). The number of chains 52 used can correspond with the number of drive sprockets 56 affixed to the shaft 57. In the example shown in FIG. 2, four (4) chains 52a, 52b, 52c and 52d are used, although it can be appreciated that the number can vary. A plurality of identical slats 80 may have opposite ends connected to adjacent chains 52, which may be spaced at regular intervals along the lengths of the chains 52. As shown, in some embodiments, one end of each slat 80 may be connected to the center chain (52b, 52c), while the outer end of alternating slats 80 can be connected to one of the outer chains (52a, 52d). The outer ends of the remaining slats 80 can be attached to the other center chain (52b, 52c), so that the slats 80 are staggered for increased crop processing efficiency. The feeder house drum 60 can be mounted near the sprockets (56a, 56b, 56c) to collect the crop as it moves up the feeder house assembly. The feeder house drum 60 may comprise a plurality of paddles 62 each having a respective brush assembly 64 that firmly but gently grabs the crop from the feeder house assembly and sweeps the same into a separator mechanism 70.

In some embodiments, the feeder house drum 60 may comprise a cylinder 59 coupled to at least one metal paddle 62 having a brush assembly 64. In some embodiments, the feeder house drum 60 can be coupled to at least one non-metal paddle 62, wherein the paddle 62 may be coupled to the feeder house drum 60 with and without the brush assembly 64. In some embodiments, the brush assembly 64 can fully cover the outer edge of the paddle 62. In other embodiments, the brush assembly 64 may couple to a forward or rearward portion of the paddle 62.

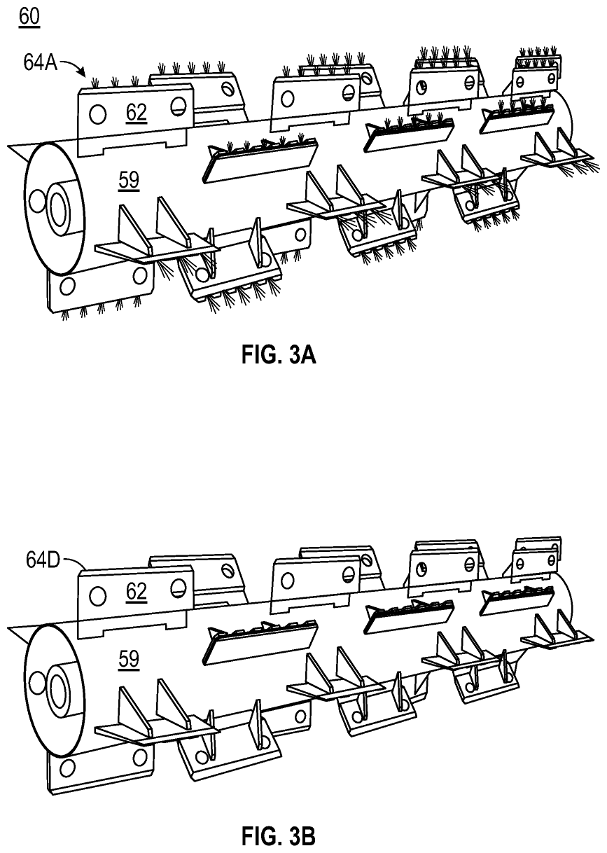

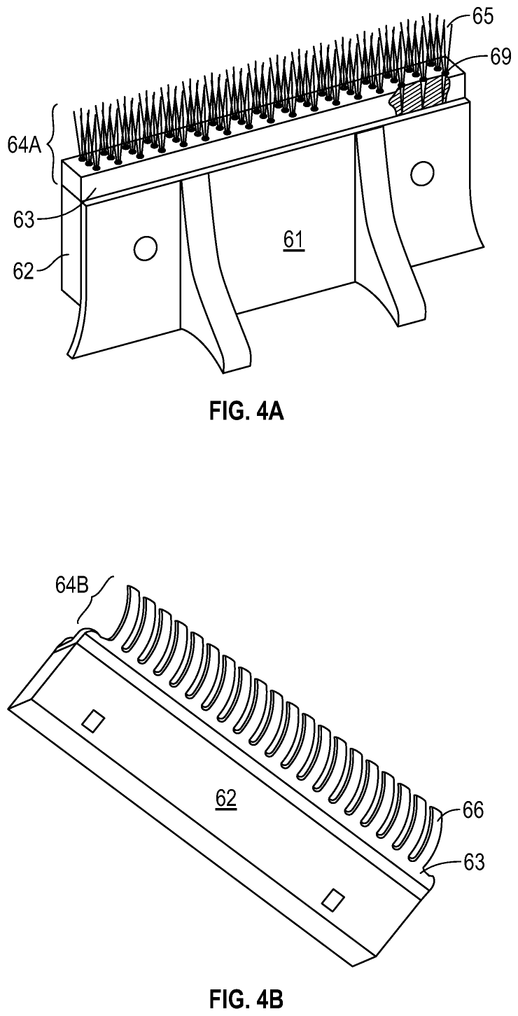

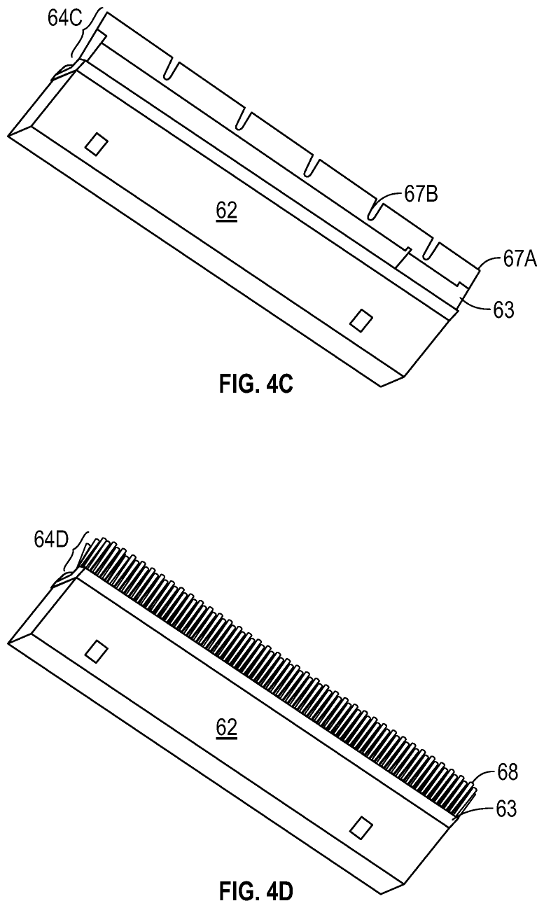

Each paddle 62 may include a brush assembly 64 that provides sufficient grasp without having a damaging effect upon the crops, wherein the crop throughput is improved while reducing damage to the crop. As can be seen in FIGS. 3A, 4A, 4B, and 4D, the brush assembly 64 on each paddle 62 of the feeder house drum 60 may include at least one row of finger members (65, 66, 68) coupled to a brush base 63. The brush base 63 may couple to the paddle base 62 of the drum 60. The brush base 63 may also include a plurality of through-material recesses 61 at the outer ends of the base 63 for fastening the paddles 62 to the feeder house drum 60; wherein, the fastening means may include, for example, rivets, solder, nuts, bolts, and the like. As shown, the paddles include one or more different types of brush assemblies. In particular as shown in FIG. 3A, a perspective view of one embodiment of a feeder house drum with a plurality of paddles having a full head brush assembly in accordance with some embodiments is illustrated.

Referring to FIG. 3B, a perspective view of one embodiment of a feeder house drum with a plurality of paddles having a full panel assembly in accordance with some embodiments is displayed. In particular each paddle 62 may be comprised of a flexible material such as rubber, composite rubber, plastic, composite plastic, and the like. Since the material of the paddle can be rigid, semi-rigid, and/or flexible, the crops do not suffer harm or damage when they are swept up towards the separator mechanism 70.

Referring now to FIG. 4A, a perspective view of one embodiment of a paddle anchor 61 having a brush assembly covering a portion of the paddle base in accordance with some embodiments is shown. In particular, each paddle may include a paddle base 62 and a brush assembly 64a. Each paddle base 62 may include a plurality of through-material recesses (not shown) at outer ends of the paddle base for securing the paddle base 62 to the paddle anchor 61, which coupled to the cylinder 59 of the feeder house drum 60 (as shown in FIG. 3A). The brush assembly 64a may include a brush base 63 having a forward end and a rearward end; wherein at least one row of finger members 65 may couple to either end of the brush base 63. In some embodiments as shown, three rows of finger members 65 may be arranged in tufts and received in stepped openings 69 through the brush base 63. Each brush base 63 may couple to a respective one of the paddle bases 62, wherein each paddle base 62 couples to a respective paddle anchor 61 of the drum 60. In the alternative, the brush base 63 may also include a plurality of through-material recesses for fastening the brush base 63 to the paddle anchor 61 without a separate paddle base 62. The fastening means for coupling the paddle base 62 or the brush base to the paddle anchor 61 may include, for example, rivets, solder, nuts, bolts, and the like. In some embodiments, the finger members 65 may include at least one row of straight or curved brush bristles. Although three rows of finger members 65 are shown, those skilled in the art could appreciate that the brush assembly 64 may be comprised of one or more rows of finger members 65. As can be appreciated by those skilled in the art, the finger members 65 may be selected from a group consisting of rigid, semi-rigid, and/or flexible materials. In particular, the finger members 65 may be composed or constructed of but not limited to metal, alloy, composite rubber, composite plastics, composite fabric material, and the like. These may be manufactured by either fabrication of one or more individual parts coupled together or by casting or molding of parts from raw material. In some embodiments, the brush base 63 and the finger members 65 may be manufactured from one mold, wherein the brush base 63 and finger members 65 are one inseparable unit. In some embodiments, the paddle base 62 and the brush assembly 64a may be manufactured from one mold, wherein the paddle base 62 and the brush assembly 64a are one inseparable unit.

Turning to FIG. 4B, a perspective view of one embodiment of a sweep assembly having a brush assembly covering a portion of the paddle base including curved elongated fingers in accordance with some embodiments is displayed. In particular, each paddle assembly may include a paddle base 62 and a brush assembly 64b. Each paddle base 62 may include a plurality of through-material recesses at outer ends of the paddle base for securing the paddle base 62 to the paddle anchor 61, which couples to the cylinder 59 of the feeder house drum 60. The brush assembly may include a brush base 63 having a forward end and a rearward end; wherein at least one row of curved elongated fingers 66 may couple to the either the forward end or the rearward end of the brush base 63 that couples to the paddle base 62. In the alternative, the finger members may include at least one row of flat rectangular elongated fingers (not shown) in some embodiments. As can be appreciated by those skilled in the art, the curved elongated fingers 66 may be selected from a group consisting of rigid, semi-rigid, and/or flexible materials. In particular, the curved elongated fingers 66 may be composed or constructed of but not limited to metal, alloy, composite rubber, composite plastics, composite fabric material, and the like. These may be manufactured by either fabrication of one or more individual parts coupled together or by casting or molding of parts from raw material. In some embodiments, the brush base 63 and the curved elongated fingers 66 may be manufactured from one mold, wherein the brush base 63 and curved elongated fingers 66 are one inseparable unit. In some embodiments, the paddle base 62 and the brush assembly 64b may be manufactured from one mold, wherein the paddle base 62 and the brush assembly 64b are one inseparable unit.

Referring to FIG. 4C, a perspective view of one embodiment of a paddle having a sweep assembly covering a portion of the paddle base including panel having notches in accordance with some embodiments is illustrated. In particular, each paddle may include a paddle base 62 and a panel assembly 64c. Each paddle base 62 may include a plurality of through-material recesses at outer ends of the paddle base for securing the paddle base 62 to the paddle anchor 61, which couples to the cylinder 59 of the feeder house drum 60. The brush assembly may include a brush base 63 having a forward end and a rearward end; wherein at least one panel 67a having notches 67b may couple to the forward end of the brush base 63 that couples to the paddle base 62. In particular as show, the panel 67a may include one or more notches 67b. As can be appreciated by those skilled in the art, panel 67a can be flat without notches and still effectively pull the crop material from the feeder house without any damage to the crop. In particular, although the figure shows five notches (67b), those skilled in the art could appreciate that the panel 67a may include one or more notches. In the alternative, the panel may be one flat surface, excluding the notches (not shown) in some embodiments. Each panel 67a may be selected from a group consisting of rigid, semi-rigid, and/or flexible materials. In particular, the panel 67a may be composed or constructed of but not limited to metal, alloy, composite rubber, composite plastics, composite fabric material, and the like. These may be manufactured by either fabrication of one or more individual parts coupled together or by casting or molding of parts from raw material. In some embodiments, the brush base 63 and the panel 67a may be manufactured from one mold, wherein the brush base 63 and panel 67a are one inseparable unit. In some embodiments, the paddle base 62 and the brush assembly 64c may be manufactured from one mold, wherein the paddle base 62 and the brush assembly 64c are one inseparable unit.

Referring now to FIG. 4D, a perspective view of one embodiment of a paddle having a brush assembly covering a portion of the paddle base including elongated cylindrical fingers in accordance with some embodiments is shown. In particular, each paddle may include a paddle base 62 and a brush assembly 64d. Each paddle base may include a plurality of through-material recesses at outer ends of the paddle base for securing the paddle base 62 to the paddle anchor 61, which couples to the cylinder 59 of the feeder house drum 60. The brush assembly may include a brush base 63 having a forward end and a rearward end; wherein at least one row of elongated cylindrical fingers 68 may couple to the forward end of the brush base 63 that couples to the paddle base 62. As can be appreciated by those skilled in the art, the elongated cylindrical fingers 68 may be selected from a group consisting of rigid, semi-rigid, and/or flexible materials. In particular, the elongated cylindrical fingers 68 may be composed or constructed of but not limited to metal, alloy, composite rubber, composite plastics, composite fabric material, and the like. These may be manufactured by either fabrication of one or more individual parts coupled together or by casting or molding of parts from raw material. In some embodiments, the brush base 63 and the elongated cylindrical fingers 68 may be manufactured from one mold, wherein the brush base 63 and elongated cylindrical fingers 68 are one inseparable unit. In some embodiments, the paddle base 62 and the brush assembly 64d may be manufactured from one mold, wherein the paddle base 62 and the brush assembly 64d are one inseparable unit

In some embodiments, the brush assembly 64a, 64b, 64c and 64d may comprise rubber, composite rubber, plastic, composite plastic, and the like. As can be appreciated by those skilled in the art, the rigid, semi-rigid, and/or flexible members may include one or more rows of bristles, fingers, tines, teeth, panels and the like. These may be composed or constructed of but not limited to metal, alloy, rubber, plastics, composite fabric material and the like. These may be manufactured by either fabrication of two or more individual parts coupled together or by casting or molding of parts from raw material.

In operation, crop material may be provided through the harvesting platform 30 at an inlet 42 of the feeder house 40. Further, the crop material may be gripped between chain slats 80 and an interior portion 46 of the feeder house 40, wherein one or more chain slats 80 couple to a conveyor mechanism 50. The paddles of the feeder house drum 60 couples to receive the crop from the chain slats 80 of the feeder house 40, wherein the paddles may comprise a paddle base 62 having a brush assembly 64 coupled thereto. For example, at least one row of a plurality of brush bristles 65 on a leading and/or a trailing edge of each of the one or more brush base 63 may grip the crop material, wherein the brush bristles 65 retrieve the crop from the feeder house 40 without damaging the crop. In the alternative, the at least one row of a plurality of brush bristles 65 may couple to a central portion of the brush base 63. The crop material can be gripped with at least one row of a plurality of curved elongated fingers 66 (FIG. 4B) or a plurality of flat rectangular fingers (not shown). In the alternative, the material can be pulled by one or more panels 67 (FIG. 4C) or at least one row of elongated cylindrical fingers 68 (FIG. 4D). Further, the feeder house drum 60 may provide the crop material to a threshing mechanism 70 for separating the grain form the crop material other than grain. Additionally, the method may include separating the grain from the crop material other than grain, using the separator 60.

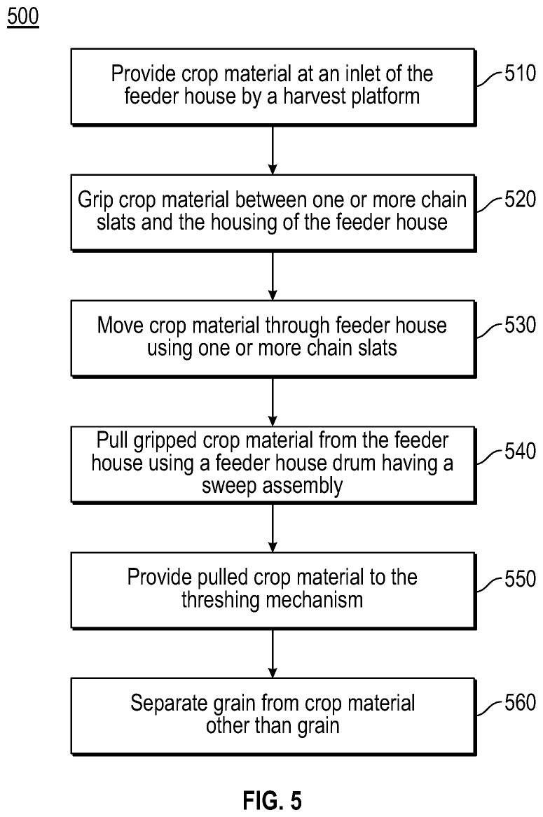

Referring now to FIG. 5, an exemplary flow diagram of a method for harvesting grain using the harvesting combine including a feeder house drum having a brush assembly, in accordance with some embodiments is shown. The method 500 for harvesting grain using the brush assembly, in accordance with some embodiments may include an action 510, wherein the combine may provide crop material at an inlet of the feeder house. For example, after the crop material is cut by the harvesting platform, the crop material is provided at the inlet of the feeder house. In an action 520, the conveyor mechanism may grip the crop material between one or more chain slats and a portion of the housing for the feeder house. For example, any portion of the interior wall of the housing may form the feeder house, such as the top or bottom floor of the feeder house. This interior wall may be used to aid in transporting the crop material. Further in an action 530, the method may include pulling the gripped crop material along the housing portion (for example, the side interior walls, top or bottom floor of the feeder house) and through the feeder house using the chain slats. Further, a feeder house drum may pull the gripped crop material from the feeder house using a sweep assembly, wherein the sweep assembly couples to each of the one or more paddle anchors connected to the cylinder of the feeder house drum in an action 540. For example, the pulling action 540 may include gripping the crop material with at least one row of a plurality of brush bristles on a leading edge or full surface of each of the one or more panels, wherein the brush bristles can be curved or straight for retrieving the crop from the harvesting platform without damaging the crop. The crop material may be gripped with at least one row of a plurality of curved elongated fingers, or at least one row of a plurality of flat rectangular fingers that curve to retrieve the crop from the feeder house. Additionally, in an action 550, the method can include providing the crop material to a threshing mechanism for separating the grain form the crop material other than grain using the brush mechanism. Further, the method may include separating the grain from the crop material other than grain, in an action 560.

In the above description, numerous details are set forth. It will be apparent, however, to one skilled in the art, that the present invention may be practiced without these specific details. It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled. Although detailed illustrative embodiments are disclosed herein, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

What is claimed is:

1. A combine for harvesting a crop bearing grain, the combine comprising:
a harvesting platform;
a feeder house mechanism having a conveyor for receiving crop form the harvesting platform at a forward crop inlet and delivering crop to a rear opening;
a feeder house drum having a plurality of paddles each having a sweep assembly for retrieving the crop from the feeder house mechanism, wherein the feeder house drum coupled to receive the crop from the rear opening without damaging the crop; and
a separator mechanism coupled to the feeder house drum to receive the crop to separate the grain from the crop.

2. The combine of claim 1, wherein the feeder house drum comprises:
a cylinder; and
a plurality of paddle anchors coupled to the cylinder, wherein the plurality of paddles couple to the plurality of paddle anchors.

3. The combine of claim 2, wherein each one of the plurality of paddles comprises:
a paddle base; and
a brush assembly coupled to the paddle base;
wherein the paddle base having one or more through-material recesses for securing the paddle base to a respective one of the plurality of anchors.

4. The combine of claim 3, wherein the brush assembly comprises:
a brush base; and
at least one row of finger members coupled to the brush base, wherein the at least one row of finger members are selected from a group consisting of rigid, semi-rigid, and flexible materials.

5. The combine of claim 4, wherein the at least one row of finger members comprises:
a plurality of brush bristles arranged in tufts, wherein the plurality of brush bristles are received in a respective one of a plurality of stepped openings through the brush base.

6. The combine of claim 4, wherein the at least one row of finger members comprises:
at least one row of elongated fingers, wherein the at least one row of elongated fingers are curved to hook the crop without damaging the crop.

7. The combine of claim 4, wherein the at least one row of finger members comprise:
at least one row of flat rectangular fingers, wherein one of the at least one row of flat rectangular fingers is curved to hook the crop without damaging the crop.

8. A feeder house drum in a harvesting machine such as a combine, the feeder house drum comprising:
a cylinder;
a plurality of paddle anchors coupled to the cylinder; and
a plurality of sweep assemblies coupled to the plurality of paddle anchors.

9. The feeder house drum of claim 8, wherein each one of the plurality of sweep assemblies comprises:
a paddle base; and
a brush assembly coupled to the paddle base;
wherein the paddle base having one or more through-material recesses for securing the paddle base to a respective one of the plurality of paddle anchors.

10. The feeder house drum of claim 9, wherein the brush assembly comprises:
a brush base; and
at least one row of finger members coupled to the brush base, wherein the at least one row of finger members are selected from a group consisting of rigid, semi-rigid, and flexible materials.

11. The feeder house drum of claim 10, wherein the at least one row of finger members comprises:
a plurality of brush bristles arranged in tufts, wherein the plurality of brush bristles are received in a respective one of a plurality of stepped openings through the brush base.

12. The feeder house drum of claim 10, wherein the at least one row of finger members comprises:
at least one row of elongated fingers, wherein the at least one row of elongated fingers are curved to hook the crop without damaging the crop.

13. The feeder house drum of claim 10, wherein the at least one row of finger members comprise:
at least one row of flat rectangular fingers, wherein one of the at least one row of flat rectangular fingers is curved to hook the crop without damaging the crop.

14. The feeder house drum of claim 8, wherein each one of the plurality of sweep assemblies comprises:
a paddle base; and
a panel assembly coupled to the paddle base, wherein the panel assembly is selected from a group consisting of rigid, semi-rigid, and flexible materials;
wherein the paddle base having one or more through-material recesses for securing the paddle base to a respective one of the plurality of paddle anchors.

15. A method of processing of crop material through a combine feeder house having a transverse mounted drum mounted on a shaft at a front thereof and one or more drive sprockets at a rear thereof with one or more chains positioned around and rotating around the transverse mounted drum and one or more drive sprockets, with one or more chain slats positioned parallel to the transverse drum, the method comprising:
providing crop material at an inlet of the feeder house;
gripping the crop material using a conveyor within the feeder house; and
pulling the gripped crop material from the conveyor by a feeder house drum having one or more paddle anchors, wherein a sweep assembly couples to the one or more paddle anchors to pull the crop without damage.

16. The method of claim 15, wherein the pulling of the crop material comprises:
grasping the crop material with at least one row of a plurality of finger members on at least one edge of the sweep assembly, wherein the plurality of finger members retrieve the crop from the combine feeder house without damaging the crop.

17. The method of claim 15, wherein the pulling of the crop material comprises:
grasping the crop material with at least one row of a plurality of curved brush bristles on at least one edge of the sweep assembly, wherein the curved brush bristles retrieve the crop from the combine feeder house without damaging the crop.

18. The method of claim 15, wherein the gripping of the crop material comprises:
grasping the crop material with at least one row of a plurality of flat rectangular fingers on at least one edge of the sweep assembly, wherein the flat rectangular fingers are curved retrieve the crop from the combine feeder house without damaging the crop.

19. The method of claim 15, further comprising:
providing the crop material to a threshing mechanism for separating the grain from the crop material other than grain.

20. The method of claim 19, further comprising:
separating the grain from the crop material other than grain.
